(19) United States
(12) Patent Application Publication
(10) Pub. No.: US 2015/0041392 A1
(43) Pub. Date: Feb. 12, 2015

(54) METHOD AND SYSTEM USING MICRO/NANO BUBBLES FOR ENHANCED IN SITU REMEDIATION OF POLLUTED GROUNDWATER

(71) Applicants: Dejun Song, (US); Tsinghua University, Beijing (CN)

(72) Inventors: Liming Hu, Beijing (CN); Dejun Song, Aichi (JP); Hengzhen Li, Beijing (CN)

(21) Appl. No.: 14/380,039

(22) PCT Filed: Jan. 21, 2013
(86) PCT No.: PCT/CN2013/000063

§ 371 Date: Aug. 20, 2014

(30) Foreign Application Priority Data
Feb. 21, 2012 (CN) 201210041356.6

(51) Int. Cl. C02F 3/02; C02F 1/72

(52) U.S. Cl. CPC C02F 3/02; C02F 1/72; C02F 2101/32
USPC 210/610; 210/85

(57) ABSTRACT

Provided is a method using micro/nano bubbles for enhanced in situ remediation of polluted groundwater, comprising: arranging a water injection pipe (7) at an upstream location of an area where groundwater is polluted; introducing thereto a micro/nano bubbles-containing water having nutrient salt(s) therein; transferring the micro/nano bubbles-containing water having nutrient salt(s) with the movement of groundwater to the polluted area, decomposing organic pollutants or continuously replenishing electron acceptor(s)/donor(s) for microorganisms to facilitate the degradation and removal of the organic pollutants; meanwhile, arranging a water extraction pipe (17) at the downstream of the polluted area to extract water and form a groundwater flow-field; setting up a monitoring well for real-time monitoring and analyzing of parameters during the removal process of the organic pollutants and adjusting the occurrence time and the amount of aeration of the micro/nano bubbles. Also provided is a system using the micro/nano bubbles for enhanced in situ remediation of the polluted groundwater. The micro/nano bubbles have a great oxygen-supplying effect, a long duration, and a large influence area, compensate for deficiencies of regular in situ remediation technologies such as natural degradation and bioventing, are of reduced costs and energy efficient, and are applicable in remediation of sites with a limited area and a high pollution load.

### FIELD OF THE INVENTION

The present invention belongs to the technical field of remediation of polluted groundwater. Especially, the present invention relates to a method and a system for enhanced in situ remediation of polluted groundwater by using micro/nano bubbles.

### BACKGROUND OF THE INVENTION

Both environment and development are important issues that are of concern by the human society. In order to achieve a sustainable development, protection and control of environment should be an important part of the development. Groundwater, as an important constituent of water resources worldwide, plays an important role in the development of economy and society, especially when the surface water has been severely polluted. In recent years, the problem of worldwide environmental pollution is becoming severe, due to the rapid development of economy and the production of a large amount of industrial wastes. Nowadays, there is a significant trend that the quality of groundwater is worsening and the situation is becoming very serious. In many areas, groundwater has been more or less polluted by toxic or poisonous, organic or inorganic pollutants. The “Twelfth Five-Year Plan” of China advises “strengthening environment protection”, “resolving the outstanding environmental problems that are harmful to human health, such as soil pollution”, and “strengthening the prevention and control of groundwater pollution”. “National Planning for Prevention and Control of Groundwater Pollution (2011-2020)”, released on October, 2011, pointed out “preliminarily restraining the worsening trend of the quality of groundwater”, “strengthening the supervision of groundwater environment in main industries”, and “systematically accelerating the remediation of polluted groundwater”. The development and application of innovative, environment-friendly, and cost effective remediation techniques for polluted groundwater are important approaches for a sustainable development of economy and society.

In situ remediation of groundwater has been rapidly developed and become a predominant technique in remediation of groundwater, due to its low cost and low interference to environment. Aeration of groundwater, pumping and treating, and biological strengthening technique are regular techniques for in situ remediation of polluted groundwater, and are regularly applied in fields with a limited area and a high pollution load. In regular aeration of groundwater, a compressed air is injected through an aeration well into a saturated soil and groundwater, thereby an up-flow of the air results in desorption and volatilization of pollutant components in the soil and groundwater, and such pollutant components enter into an unsaturated area of the soil along with the airflow. Meanwhile, oxygen in the airflow is continuously dissolved in the water contained in the soil, such that the content of dissolved oxygen is increased, which is benefit to aerobic microorganisms and in turn accelerates the microbial degradation of the organic pollutant in groundwater. Biological remediation has been emerged and developed since 1980's, and is a bio-engineering technique for removing and controlling environmental pollution, which utilizes a particular ability of microorganisms in degrading toxic and poisonous substances to remove the pollutants in polluted environment and hence remove environmental pollution. Conventionally, electro-biofilm reactor (EBR) improves environmental condition for the growth of microorganisms and the degradation function of the microorganisms, provides sufficient electron acceptor(s)/donor(s) and nutrient salt(s), and improves the metabolism and degradation activity of the microorganisms, so as to accelerate the degradation speed of the pollutants. EBR can provide a direct remediation for main polluted areas. Pumping and treating, hereinafter referred to as P&T, is a traditional remediation process for groundwater, and is carried out by appropriately designing water pumping well(s) and flow-field of groundwater so as to form a trapping area encompassing the entire pollution plume of groundwater, and continuously pumping of polluted groundwater so as to gradually reduce the area and degree of pollution of the polluted plume and transfer the pollutants in the media of the aqueous layer into water and hence eliminate them. Conventionally, EBR is combined with P&T, and thus the movement of groundwater is utilized to transfer electron acceptor(s)/donor(s) and nutrient salt(s) so as to improve the activity of microorganisms. Although EBR is environment-friendly and has a great potential in development, one of its problems is how to transfer electron acceptor(s)/donor(s) and nutrient salt(s) with a high efficiency so as to provide a good environmental condition for microorganisms. Therefore, a technique for transferring electron acceptor(s)/donor(s) and nutrient salt(s) with a good oxygen-supplying effect, a long duration, and a large influence area becomes a key technique and a trend for EBR. In addition, in areas with a high pollutant load such as the pollution source, the degradation effect of microorganisms is greatly inhibited due to that the activity of microorganisms is inhibited by the pollutants. Therefore, it is also an important task to decrease the concentration of pollutants to an extent that is tolerable to microorganisms.

Electron acceptor(s)/donor(s) are mainly provided by a gas. Regular gases include air, oxygen, hydrogen, etc. In order to increase the amount of gases dissolved in groundwater and the ability of continuous supplying, it is a pivotal technique to decrease the diameter of bubbles so as to increase the inner pressure of the bubbles and the residence period of the bubbles in water body. Nowadays, techniques for producing micro/nano bubbles are well established, and bubbles in groundwater can reach a micro/nano level using certain devices. Such micro/nano bubbles have a smaller diameter and a longer residence time in the water body, and can move along with groundwater, and have a transfer and influence area much larger than that of regular bubbles, and have a larger inner pressure; and their high solubility can provide a high content of dissolved oxygen to the water body. Meanwhile, the gas-liquid interface of the micro/nano bubbles carries negative charges, which can interact with specific pollutants, and the free radicals and vibration waves produced during the rupture of the bubbles facilitate the removal of pollutants. Conventionally, nutrient salt(s) is/are added into groundwater directly, and then transferred via the underground flow-field, and thereby, the environmental condition for the microorganisms can be further improved, which facilitates the degradation by microorganisms.

In areas with a high concentration of pollutants, the method of directly oxidizing pollutants by injecting an oxidant such as ozone, Fenton (a combination of ferrous salts and hydrogen peroxide), etc., has the same disadvantage as the aeration of groundwater. However, such problems can be solved by micro/nano bubbles with a low concentration of ozone as an injection gas; thereby, the concentration of pollutants can be reduced in a short period to an extent that is tolerable to microorganisms. Ozone produces oxygen, which has no adverse effects to the subsequent microorganism degradation. Micro/nano bubbles have a good oxygen-supplying effect, a long duration, and a large influence area, and, in combination with P&T, can compensate for deficiencies of regular in situ remediation technologies such as aeration of groundwater, P&T, and EBR, and facilitate the microbial degradation and the remediation of polluted groundwater.

According to the present invention, micro/nano bubbles-containing water is injected into the groundwater system via a micro/nano bubble aeration equipment. The injection can be conducted by stages and/or by areas depending on the type and concentration of pollutants and the hydrological and geological conditions. The gas being injected can be ozone, and can also be an electron acceptor such as air and oxygen, and an electron donor such as hydrogen. Meanwhile, an equipment for adding nutrient salt(s) is placed at the water outlet of the micro/nano bubble aeration equipment in order to add nutrient salt(s) to groundwater. By virtue of the combined action of water injecting well(s) and water pumping well(s), the flow-field characteristics of the groundwater are adjusted, and the micro/nano bubbles and nutrient salt(s) are transferred to specific areas to remediate the polluted field.

The present invention provides a technique for remediation of groundwater, which is environment-friendly and energy efficient.

### SUMMARY OF THE INVENTION

The present invention provides a method and a system for enhanced in situ remediation of polluted groundwater by using micro/nano bubbles. Such method and system can in situ remediate polluted groundwater under various conditions of hydrology, geology and environment, and on various organically polluted fields. Meanwhile, such method and system can monitor and analyze various parameters during the remediation, such as the concentration of pollutants, the population and amount of microorganisms, temperature, pH value, and the ability of electron interexchange, and thus provide experimental data for related scientific studies.

The method for enhanced in situ remediation of polluted groundwater by using micro/nano bubbles according to the present invention comprises the following steps:
(1) setting up one or more water injecting wells at an upstream location of an area where groundwater is polluted, generating micro/nano bubbles-containing water via a micro/nano bubble aeration equipment using a gas and water, and adding nutrient salt(s) to the micro/nano bubbles-containing water, which is then introduced into the groundwater system through the water injecting well;
(2) transferring and dispersing the micro/nano bubbles and the nutrient salt(s) with the movement of the groundwater, directly decomposing organic pollutants or continuously replenishing electron acceptor(s)/donor(s) and nutrient salt(s) for microorganisms to facilitate the degradation and removal of the organic pollutants;
(3) setting up one or more water pumping wells at a downstream location of the area where the groundwater is polluted, pumping out the groundwater and conducting a treatment, forming an artificial groundwater flow-field to control the transfer range of the micro/nano bubbles in order to improve overall remediation efficiency of the field and prevent the pollution range from extending;
(4) arranging multiple monitoring wells, which are communicated with the ground, at various locations of the area where the groundwater is polluted, performing real-time monitoring and analyzing of various parameters during the removal process of the organic pollutants by using the monitoring wells, and, on the basis of the analysis results, adjusting the occurrence time and the amount of aeration of the micro/nano bubbles as well as the artificial groundwater flow-field.

The concentration of the organic pollutants is 5,000 ppm-10,000 ppm.

The size of the micro/nano bubbles is in a range of from 100 nm to 0.2 mm.

The physical method includes filtration and gravitational segregation. The chemical method includes agent-adding method, electrolysis, and ion-exchange method. The biological method includes activated sludge method and biofilm method.

The gas is an electron donor or an electron acceptor, and is selected from air, oxygen, ozone, and hydrogen.

The nutrient salt(s) is/are one or more of amino acids, vitamins, and compounds containing carbon, nitrogen, phosphor, or microelements.

The system for enhanced in situ remediation of polluted groundwater by using micro/nano bubbles according to the present invention comprises:
One or more water injecting wells arranged at an upstream location of an area where groundwater is polluted;
Multiple monitoring wells arranged at various locations above the area where the groundwater is polluted;
One or more water pumping wells arranged at a downstream location of the area where the groundwater is polluted;
A micro/nano bubble aeration equipment disposed on the ground, wherein a gas-supplying equipment and a water tank are connected with the micro/nano bubble aeration equipment via a gas-supplying pipe and a water-supplying pipe, respectively, the outlet of the micro/nano bubble aeration equipment is connected with an equipment for adding nutrient salt(s), and then protrudes into the water injecting well through a water injection pipe;
A water quality monitoring sensor arranged in each monitoring well;
A water pump arranged on the ground near the water pumping well, wherein the water inlet of the water pump is connected with a water pumping pipe protruding into the water pumping well, and the water outlet of the water pump is connected with a water treatment equipment.

The water inflow and water outflow of the micro/nano bubble aeration equipment are 10 L/min-200 L/min, and the size of the micro/nano bubbles generated is in a range of from 100 nm to 0.2 mm.

The gas-supplying pipe is equipped with a gas flowmeter, a barometer, and a pneumatic valve.

The water-supplying pipe is equipped with a hydraulic valve and a water flowmeter.

The main mechanism of the removal of organic pollutants by the micro/nano bubbles according to the present invention consists in:
(1) The micro/nano bubbles increase the amount of dissolved ozone in groundwater, which directly degrades high concentration organic pollutants (such as petroleum hydrocarbons and organic chlorides). The micro/nano bubbles increase the amount of dissolved oxygen in groundwater, which facilitates the growth of aerobic microorganisms and the degradation of organic pollutants (such as petroleum hydrocarbons). The population of aerobic microorganisms can be over 10 times than before. The micro/nano bubbles increases the amount of dissolved hydrogen in groundwater, which facilitates the growth of anaerobic dechlorination microorganisms and the degradation of organic pollutants (such as organic chlorides). Meanwhile, the nutrient salt(s) added into the micro/nano bubbles-containing water can also facilitate the activity of microorganisms, and facilitate the degradation of pollutants.

(2) The pollutants that are adsorbed on soil particles are rinsed off by using the groundwater flow-field, and the polluted water that is pumped out from the water pumping well is subjected to a further treatment.
(3) The micro/nano bubbles carry charges on their surface, which have adsorption effect on the pollutants.
(4) The micro/nano bubbles, upon rupture, release energy and form hydroxyl free radicals, which have an oxidative degradation effect on the pollutants.

The present invention provides the following beneficial effects:
(1) The type and concentration of the injected gas(es), and the details of the designed remediation process can be selected according to the conditions of hydrology and geology in various fields as well as the condition of organic pollution (type, concentration, etc.). The present invention is of characteristics of reduced cost, friendly to environment and energy efficient and is suitable for remediation of places with a limited size and a high pollution load.
(2) Various parameters, mainly including the concentration of pollutants, the population and amount of microorganisms, temperature, pH value, and the ability of electron interexchange, can be monitored on line, and the effect of remediation can be analyzed and evaluated scientifically, which further reduces the cost and improves the remediation efficiency.
(3) This technique stimulates and facilitates the growth and reproduction of indigenous microorganisms, and does not introduce any other environmental microorganisms, and thus is of little influences to the environment and ecology.
(4) Water injecting well(s), monitoring well(s), and water pumping well(s) required by the technique can partly employ existing well positions, with a low initial cost and running expense.
(5) The relative equipments can be recycled and reused after the groundwater remediation achieves the environment standard.

### DESCRIPTION OF THE FIGURES

FIG. 1 is a schematic drawing of partial structures of the micro/nano bubble aeration equipment and the water injecting well.

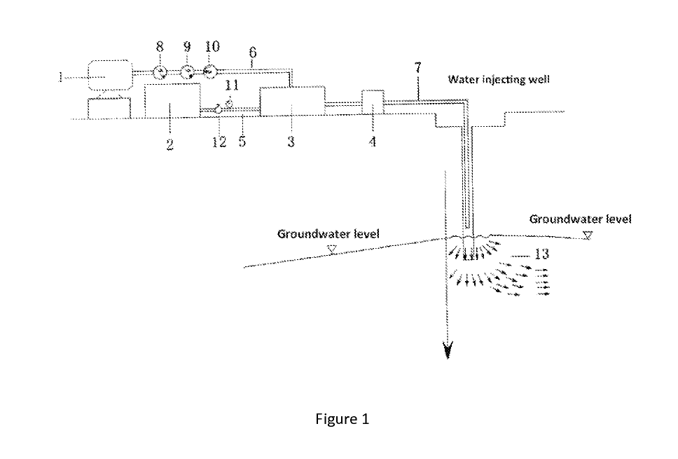

FIG. 2 is a schematic drawing of the overall removal process of pollutants in groundwater.

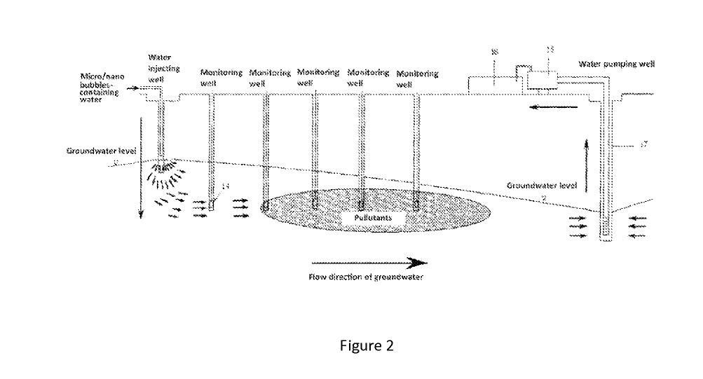

The reference signs in the figures:
1—Gas-supplying equipment;
2—Water tank;
3—Micro/nano bubble aeration equipment;
4—Equipment for adding nutrient salt(s);
5—Water-supplying pipe;
6—Gas-supplying pipe;
7—Water injection pipe;
8—Gas flowmeter;
9—Barometer;
10—Pneumatic valve;
11—Water flowmeter;
12—Hydraulic valve;
13—Micro/nano bubbles-containing water;
14—Water quality monitoring sensor;
15—Water pump;
16—Water treatment equipment;
17—Water pumping pipe.

### DETAILED DESCRIPTION OF THE INVENTION

The present invention provides a method and a system for enhanced in situ remediation of polluted groundwater by using micro/nano bubbles, which will be illustrated in detail, with reference to the drawings and embodiments.

An embodiment of the removal of organic pollutants from groundwater by using micro/nano bubbles aeration according to the present invention is as follows:
(1) Identifying an area where groundwater is polluted with organic pollutants, and identifying the flow direction of the groundwater; without limitation to the polluted area, the remediation has an excellent effect and is cost effective when the concentration of the organic pollutants is 5,000 ppm-10,000 ppm;
(2) Constructing a water injecting well at an upstream location of the area where the groundwater is polluted or at the area per se, or employing an existing well; arranging a micro/nano bubble aeration equipment 3 on the ground near the water injecting well, wherein a gas-supplying equipment 1 and a water tank 2 are connected with the micro/nano bubble aeration equipment 3 via a gas-supplying pipe 6 and a water-supplying pipe 5, respectively, the gas-supplying pipe 6 is equipped with a gas flowmeter 8, a barometer 9, and a pneumatic valve 10, and the water-supplying pipe 5 is equipped with a hydraulic valve 12 and a water flowmeter 11; the outlet of the micro/nano bubble aeration equipment 3 is connected with an equipment for adding nutrient salt(s) 4, and then protrudes into the water rejection well through a water injection pipe 7; the gas supplied by the gas-supplying equipment is one of air, oxygen, ozone, and hydrogen; the nutrient salt(s) is/are one or more of amino acids, vitamins, and compounds comprising carbon, nitrogen, phosphor, or microelements. The water inflow and water outflow of the micro/nano bubble aeration equipment 1 are 10 L/min-200 L/min, and the size of the generated micro/nano bubbles is in a range of from 100 nm to 0.2 mm.
(3) Setting up a water pumping well at a downstream location of the area where the groundwater is polluted, the arrangement of the water pumping well can improve the overall remediation efficiency of the field and prevent the polluted area from extending. Water pump 15 is arranged on the ground near the water pumping well, with the water inlet of the water pump is connected with a water pumping pipe 17 protruding into the water pumping well, and the water outlet of the water pump is connected with a groundwater treatment equipment 16. The polluted groundwater is pumped out using the water pump 15, subjected to water quality monitoring, and then transferred to the groundwater treatment equipment 16 where a treatment is conducted. The treatment comprises physical method (filtration, gravitational segregation and the like), chemical method (agent-adding method, electrolysis, ion-exchange method and the like), and biological method (activated sludge method, biofilm method and the like).
(4) Setting up multiple monitoring wells at various locations of the polluted area between the water injecting well and the water pumping well; and disposing a water quality monitoring sensor 14 in each monitoring well for remote monitoring, analyzing and adjusting process parameters.
(5) For a larger polluted area, arranging additional micro/nano bubble injecting well(s), water pumping well(s), and monitoring well(s) so as to cover the entire polluted area.

What is claimed is:

1. A method for enhanced in situ remediation of polluted groundwater by using micro/nano bubbles, characterized in that,
setting up one or more water injecting wells at an upstream location of an area where groundwater is polluted, generating micro/nano bubbles-containing water via a micro/nano bubble aeration equipment using a gas and water, and adding nutrient salt(s) to the micro/nano bubbles-containing water, which is then introduced into the groundwater system through the water injecting well;
transferring and dispersing the micro/nano bubbles and the nutrient salt(s) with the movement of the groundwater, directly decomposing organic pollutants or continuously replenishing electron acceptor(s)/donor(s) and nutrient salt(s) for microorganisms to facilitate the degradation and removal of the organic pollutants;
setting up one or more water pumping wells at an downstream location of the area where the groundwater is polluted, pumping out the groundwater and conducting a treatment on the ground using a physical method, a chemical method or a biological method, forming an artificial groundwater flow-field to control the transfer range of the micro/nano bubbles by pumping in order to improve overall remediation efficiency and prevent the pollution range from extending;
arranging multiple monitoring wells, which are communicated with the ground, at various locations of the area where the groundwater is polluted, performing real-time monitoring and analyzing of various parameters during the removal process of the organic pollutants by using the monitoring wells, and, on the basis of the analysis results, adjusting the occurrence time and the amount of aeration of the micro/nano bubbles as well as the artificial groundwater flow-field.

2. The method according to claim 1, characterized in that, the concentration of the organic pollutants is 5,000 ppm-10,000 ppm.

3. The method according to claim 1, characterized in that, the size of the generated micro/nano bubbles is in a range of from 100 nm to 0.2 mm.

4. The method according to claim 1, characterized in that, the gas is an electron acceptor or an electron donor, and is selected from air, oxygen, ozone and hydrogen.

5. The method according to claim 1, characterized in that, the nutrient salt(s) is/are one or more of amino acids, vitamins, and compounds containing carbon, nitrogen, phosphor, or microelements.

6. A system for enhanced in situ remediation of polluted groundwater by using micro/nano bubbles, based on the method according to claim 1, characterized in that, the system comprises:
One or more water injecting wells arranged at an upstream location of an area where groundwater is polluted,
Multiple monitoring wells arranged at various locations above the area where the groundwater is polluted,
One or more water pumping wells arranged at a downstream location of the area where the groundwater is polluted,
Micro/nano bubble aeration equipment (3) disposed on the ground, wherein a gas-supplying equipment (1) and a water tank (2) is connected with the micro/nano bubble aeration equipment (3) via a gas-supplying pipe (6) and a water-supplying pipe (5), respectively, the outlet of the micro/nano bubble aeration equipment (3) is connected with an equipment for adding nutrient salt(s) (4), and then protrudes into the water injecting well through a water injection pipe (7);
Water quality monitoring sensor arranged in each monitoring well;
Water pump (15) arranged on the ground near the water pumping well, wherein the water inlet of the water pump is connected with a water pumping pipe (17) protruding into the water pumping well, and the water outlet of the water pump is connected with a water treatment equipment (16).

7. The system according to claim 6, characterized in that, the water inflow and the water outflow of the micro/nano bubble aeration equipment (1) are 10 L/min-200 L/min, and the size of the generated micro/nano bubbles is in a range of from 100 nm to 0.2 mm.

8. The system according to claim 6, characterized in that, the gas-supplying pipe (6) is equipped with a gas flowmeter (8), a barometer (9), and a pneumatic valve (10).

9. The system according to claim 6, characterized in that, the water-supplying pipe (5) is equipped with a hydraulic valve (12) and a water flowmeter (11).
